(19) United States
(12) Patent Application Publication
(10) Pub. No.: US 2019/0244072 A1
(43) Pub. Date: Aug. 8, 2019

(54) EDGE ATTACHABLE RADIO FREQUENCY IDENTIFICATION TAGS

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 16/271,023

(22) Filed: Feb. 8, 2019

Related U.S. Application Data
(60) Provisional application No. 62/628,070, filed on Feb. 8, 2018.

(51) Int. Cl. G06K 19/077

(52) U.S. Cl. CPC G06K 19/07758; G06K 19/07773

(57) ABSTRACT

A radio frequency identification (RFID) tag includes an RFID chip, an antenna, and a substrate configured to fold into a U-shaped configuration. One end of the substrate is secured to an item of commerce after which the substrate can be folded until the opposing end of the substrate is also secured to the item. The RFID tag can include a dielectric layer adjoined to part or all of the substrate to provide additional structural support for the RFID tag. Aligned holes in the substrate allow a display rail to pass through the RFID tag. The RFID chip and antenna are configured to transmit in a direction substantially outwardly from one side of the RFID tag, allowing the RFID tag to operate even when stacked with other items. The RFID antenna and the item can operate as a loop antenna when the item is metallic.

### CROSS REFERENCE TO RELATED APPLICATION(S)

The present application claims priority to and the benefit of U.S. provisional utility patent application No. 62/628,070 filed Feb. 8, 2018, which is incorporated by reference herein in its entirety.

### TECHNICAL FIELD

The subject application generally relates to radio frequency identification (“RFID”) tags configured to attach to the edge of an item or a container and, or incorporated into a label or tag which may be attached to a container or an item, more specifically, to RFID tags configured to operate when stacked or adjacent to other containers or metals.

### BACKGROUND

Various industries pack, ship, and present for sale items for consumers. Example items include garments, electronic devices, and so forth. Items are typically manufactured in a manufacturing facility, after which the items are packed and shipped by truck or other means to warehouses or directly to stores. Inventory control at each stage, from manufacturer to warehouse to store, can be enhanced through use of a suitable RFID system using RFID tags that are attached to the items for sale.

Radio Frequency Identification (“RFID”) systems can operate at ultra-high frequency (“UHF”), including at frequencies between 860 MHz to 960 MHz. RFID transponders, such as RFID tags, typically include an antenna and/or tuning loop coupled to an RFID chip. The RFID chip receives power when excited by a nearby electromagnetic field oscillating at the resonant frequency of the RFID transponder, such as when an RFID reader interrogates the RFID tag. Once the RFID chip has received sufficient power, (e.g., such as 10 μW), the RFID chip turns on and sends a coded return signal via the antenna or tuning loop. An RFID reader interrogating the RFID tag receives and decodes the coded return signal from the RFID transponder.

Many RFID tags are passively powered, as such, the read range is typically limited to between 1 meter and 10 meters depending on the RFID reader and RFID tag hardware. When RFID tags are placed on items of commerce that are stacked together for display or shipment, it can become difficult to read individual RFID tags, especially if the items of commerce are metallic or contain liquids as those types of materials can block UHF waves. As a result, a single interrogation by an RFID reader system may result in a response from only the top item, or responses from a subset of the items in the stack depending on the relative positions of the RFID tags on the items. Similarly, when RFID tags are placed on metallic items, or positioned near metal surfaces such as might occur for items hung on display rails, especially those items near the back of display, the RFID tags may not operate as expected due to interference between the RFID antenna and nearby metals.

### SUMMARY

According to certain embodiments, a radio frequency identification (“RFID”) transponder includes a foldable substrate that is configured to fold into an approximately U-shaped configuration, an antenna that is attached to one side of the substrate, and an RFID chip that is in electrical communication with the antenna. Each end of the substrate is configured to attach to an item of commerce when the substrate is folded. The ends of the substrate can include an adhesive layer. A dielectric layer can be added to the other side of the substrate to add structure support for the RFID transponder.

In certain other embodiments, a radio frequency identification (“RFID”) tag includes a flexible substrate, an antenna in communication with one side of the substrate, an RFID chip in communication with the antenna, and one or more adhesive layers applied to some or all of the second side of the substrate for securing the substrate to an item. The substrate is configured to fold until the distal ends of the second side of the substrate are in close proximity to one another and opposing one another. The distal ends can be attached to the edge of the item, turned outwardly to attach to a common surface of the item, or secured to one another to form an RFID tag that can be attached to the side of a metal item.

According to yet other embodiments, a method includes attaching a distal portion, or end, of a substrate of a radio frequency identification (“RFID”) tag to an item of commerce, folding the substrate in half approximately at the midpoint of the substrate to approximately form a U-shaped substrate, and attaching the other distal portion of the item. The distal ends can be turned out for attachment to a planar surface of the item. The RFID tag includes an RFID chip and antenna that are positioned on the substrate such that when the substrate is folded, transmission from the RFID chip and antenna are is largely in a direction outward from one side of the RFID tag, which permits the RFID tag to operate even when the RFID tag is adjacent to a metallic surface, or adjacent to, or stacked with, other items of commerce.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top view of an RFID tag.

FIG. 2 depicts a cutaway view of an RFID tag attached to an item of commerce.

FIG. 3A depicts a first cutaway view of an example edge attached RFID tag attached to an item of commerce according to an embodiment of the disclosure.

FIG. 3B depicts a second cutaway view of an example edge attached RFID tag attached to an item of commerce according to an embodiment of the disclosure.

FIG. 4 cutaway view of an example edge attached RFID tag attached to one of a stack of items according to an embodiment of the disclosure.

FIG. 5A depicts a cutaway view of a first edge attached RFID tag having a dielectric layer according to an embodiment of the disclosure.

FIG. 5B depicts a cutaway view of a second edge attached RFID tag having a dielectric layer according to an embodiment of the disclosure.

FIG. 6A depicts a cutaway view of an edge attached RFID tag attached to the edge of an item according to an embodiment of the disclosure.

FIG. 6B depicts a cutaway view of an edge attached RFID tag attached to the side of an item according to an embodiment of the disclosure.

FIG. 6C depicts a cutaway view of an edge attached RFID tag attached to the side of a metallic item according to an embodiment of the disclosure.

FIG. 7A depicts a top view of an edge attached RFID tag with display rail holes according to an embodiment of the disclosure.

FIG. 7B depicts a perspective view of an edge attached RFID tag with display rail holes attached to an item of commerce according to an embodiment of the disclosure.

FIG. 8 depicts a side view of an edge attached RFID tag on a display rail according to an embodiment of the disclosure.

FIG. 9A depicts a side view of similarly oriented edge attached RFID tags on a display rail according to an embodiment of the disclosure.

FIG. 9B depicts a side view of edge attached RFID tags on a display rail facing in opposite orientations according to an embodiment of the disclosure.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

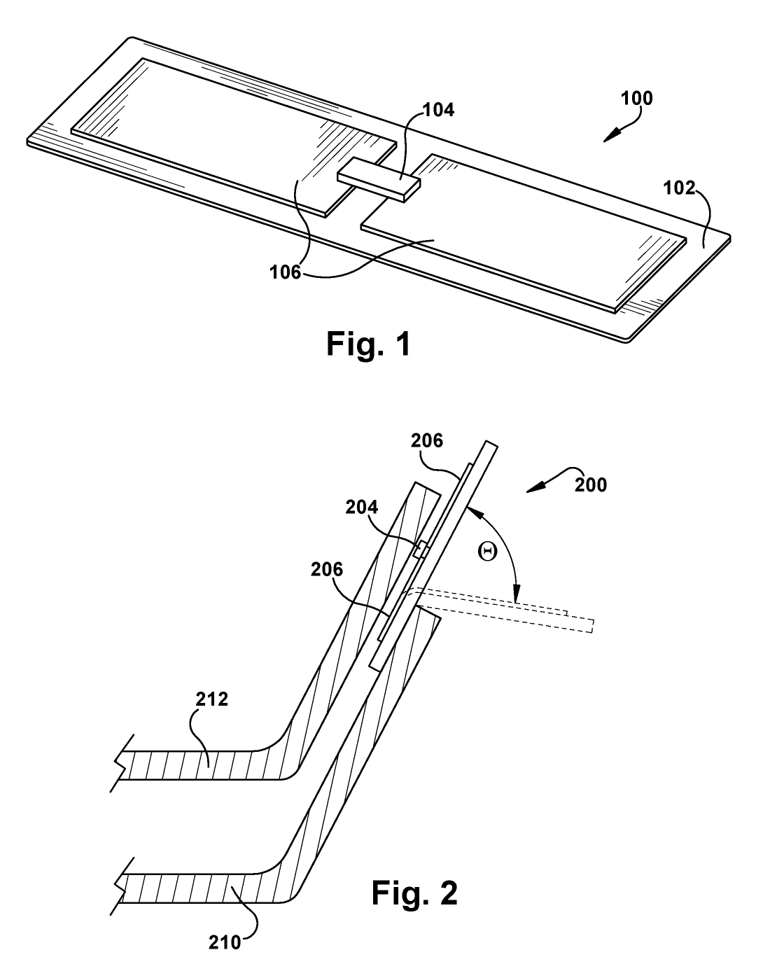

The systems and methods disclosed herein are described in detail by way of examples and with reference to FIGS. 1 to 9B. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe various methodologies for mounting RFID tags onto the edge or side of an item. Mounting RFID tags onto the edge or side of an item can allow an RFID reader system an unobstructed view of the edge-mounted RFID tags. As can be appreciated, items, including those composed of metals and liquids, can interfere with the proper operation of the RFID tags. Edge-mounted RFID tags can separate the RFID tag from the item, reducing the likelihood of interference due to the item. The present disclosure illustrates new modalities for attaching RFID tags to items. Although the systems and methods described herein are particularly applicable to RFID systems and transponders, the structures and methodologies can be adapted for use with other types of wireless tags, for example those used in Electronic Article Surveillance (“EAS”) systems.

Referring to FIG. 1, an illustration of a conventional RFID tag 100 is presented. The RFID tag 100 includes an RFID chip 104 that is electrically connected to an antenna 106, such as the simple dipole structure illustrated. The antenna 106 can include, however, any suitable structure or complex shape, such as coils or loops, as would be understood in the art. The antenna 106 is mounted onto a substrate 102 such as PET or polyethylene terephthalate, paper, or foam, which may have a face sheet suitable for printing. As can be appreciated, however, RFID tag 100 is substantially planar and can suffer performance issues when attached to stacked items and the like.

Referring to FIG. 2, an item with an RFID tag 200 is presented. The RFID tag 202 is attached to a first item 210, in this case a metal pan illustrated in a cutaway view. A second item 212, which is another metal pan, is stacked on top of the first item 210. In this illustration, the RFID tag 202 on the first item 210 may be adversely affected by the presence of the second item 212. For example, the RFID tag 202 may become folded at an angle θ or otherwise displaced from its intended orientation. The performance of the RFID tag 202 can be degraded by proximity to the first item 210 or the second item 212. For example, if the items 210, 212 are metal pans as illustrated, the proximity of the antenna 206 to the metal can result in capacitive coupling that can affect the performance of the RFID tag 202. The RFID tag 202 can also become trapped between stacked items 210, 212 reducing the amount of UHF signal received by the RFID tag 202 and emitted to an associated RFID reader system.

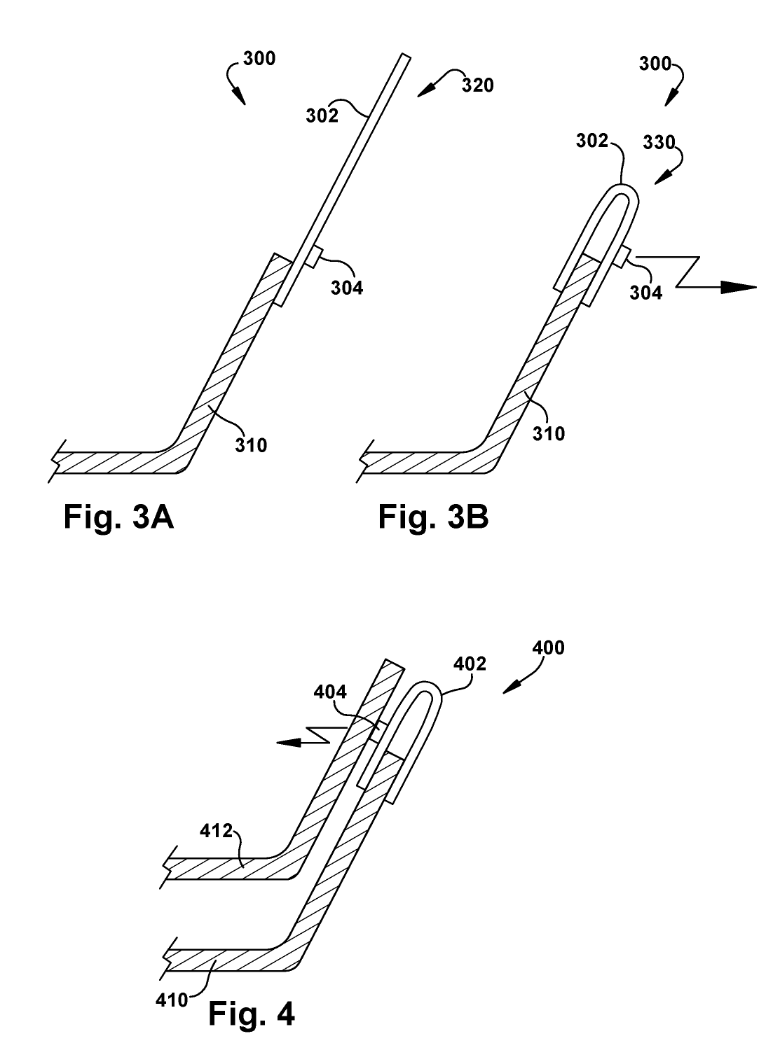

Referring to FIGS. 3A and 3B, an example edge-attachable RFID tag 300 is presented which overcomes the problems identified in FIGS. 1 and 2. In the configuration illustrated in FIG. 3A, an unfolded RFID tag 320 includes a substrate 302 with an antenna, and an RFID chip 304. The unfolded RFID tag 320 is attached to an item 310 such as a metal pan. In the configuration illustrated in FIG. 3B, unfolded RFID tag 320 is folded back on itself in a generally U-shaped configuration to become a folded RFID tag 330. The distal end portions of the folded RFID tag 330 are configured to attach to one or more edges or side surfaces of the item 310, for example using an adhesive. The folded RFID tag 330 can exhibit a number of advantages, which can differ depending on the nature of the item 310. For example, the folded RFID tag 330 structurally includes two substrate 302 surfaces opposite each other with a gap in between. This arrangement can increase structural integrity and can decrease the likelihood that the folded RFID tag 320 will fold over and become distorted or be ripped off of the item 310. In certain embodiments, the substrate 302 can be relatively thick, on the order of approximately 0.25 mm to approximately 1 mm, and can be comprised of any suitable material such as plastic, paper, or foam. The folded RFID tag 330 can maintain the antenna in a configuration which separates the two sides of the antenna from each other. In certain embodiments, the folded RFID tag 330 can be substantially aligned with an angle of an edge of the item 310.

If the item 310 is made of a non-metal material, such as plastic, the antenna of the folded RFID tag 330 can be configured to operate efficiently while still having a lower profile than the unfolded RFID tag 302. If the item 310 is made of a metal material, the two ends of the antenna can become coupled, or connected together, and can form a loop conductor with the metal of the item 310. The RFID chip 304 can be placed on the outward facing side of the folded RFID tag 330 for an improved radiation pattern, even when multiple items 310 are stacked one upon another.

Referring now to FIG. 4, in alternate embodiments, the ends of the folded RFID tag 402 and the metal item 410 can form a loop conductor with a gap between similar to the folded RFID tag 330 of FIG. 3. In contrast to FIG. 3, the RFID chip 404 can be intentionally positioned facing inwards towards the center of the metal item 410. In this orientation, when another metal item 412 is stacked on the metal item 410, the folded RFID tag 402 can be detuned and can either work only at short range or can be substantially inoperable. However, a folded RFID tag 402 attached to the metal item 412 at the top of the stack will continue to work as there is nothing above the folded RFID tag 402 to detune it. In this embodiment, an RFID reader system only needs to read a single folded RFID tag 402 at the top of the stack, reducing the number of RFID tags presented to an RFID reader system, which can improve the speed and efficiency of the RFID reader system by allowing a single read for the entire stack of metal items 410, 412.

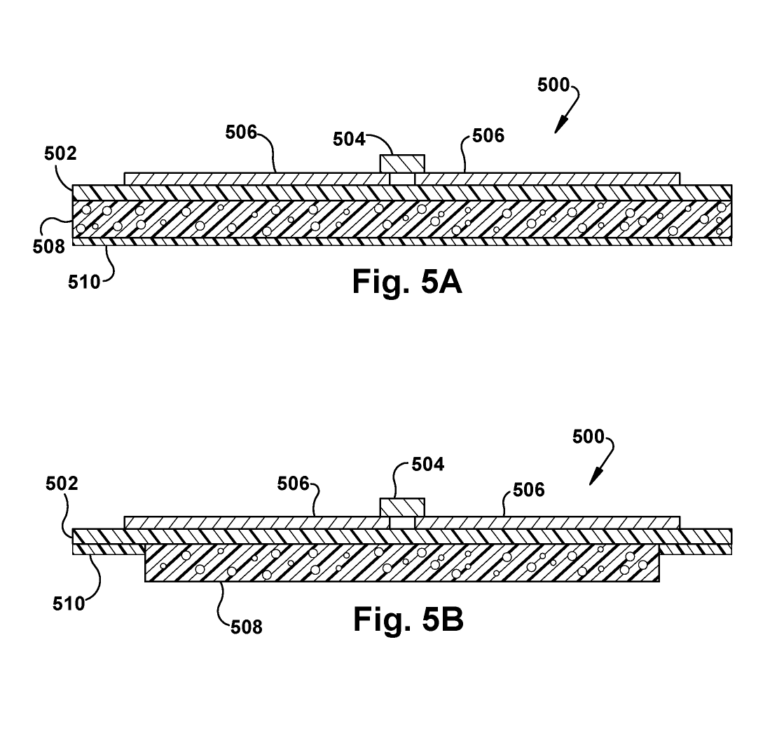

Referring to FIGS. 5A, and 5B, an edge-attachable RFID tag 500 including a substrate 502, an RFID chip 504 that bridges an antenna 506, and a dielectric 508 such as a foam or a plastic among other suitable materials is presented. The dielectric 508 can provide additional support for the edge attachable RFID tag 500 and can decrease the likelihood, or impact, of the RFID tag 500 bending out of the desired shape when attached to an item of commerce. In certain embodiments, the dielectric 508 can be applied across the entire substrate 502 as illustrated in FIG. 5A. As can be appreciated, applying the dielectric 508 across the entire substrate 502 can simplify manufacturing. An adhesive 510 can similarly be applied across the entire dielectric 508 for ease of manufacturing. In an embodiment the adhesive 510 can be selectively applied on portions of the dielectric 508.

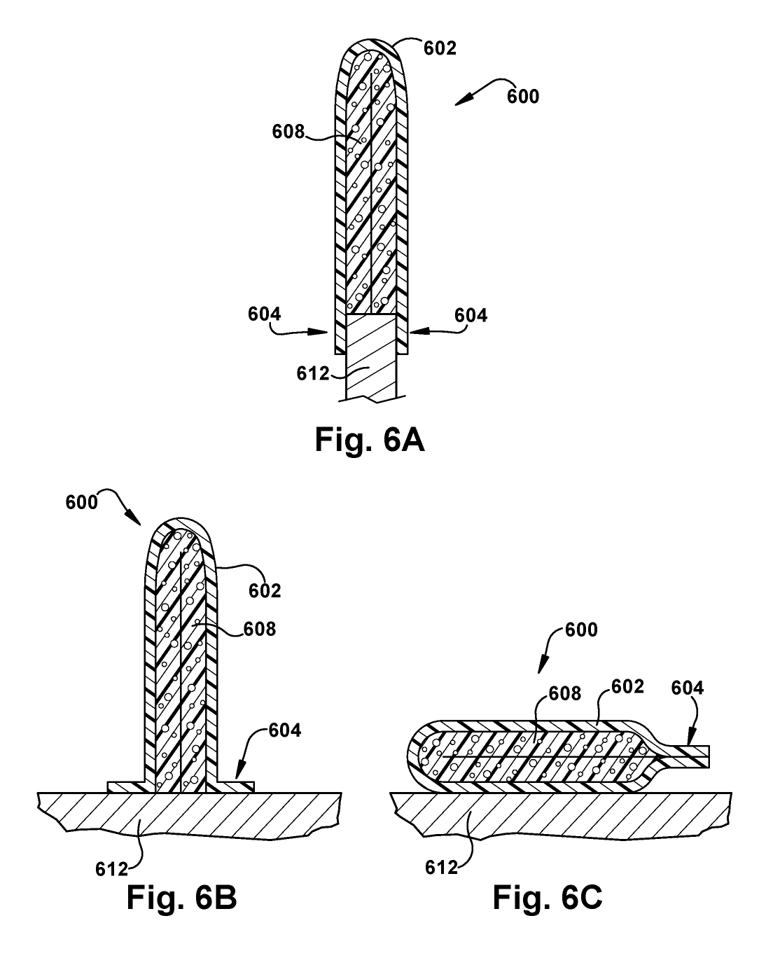

As illustrated in FIG. 5B, the dielectric 508 can alternatively be selectively applied across the center portion of the substrate 502. The adhesive 510 can be selectively applied to the edge portions of the substrate 502 and optionally on the dielectric 508 as well. Such embodiments can provide additional advantages as describe in further detail with regard to FIGS. 6A, 6B, and 6C.

FIGS. 6A, 6B, and 6C illustrate edge-attachable RFID tags 600 attached to items 612 in different configurations. Items can include the article of commerce itself or associated packaging, such as a box or a plastic container. In FIG. 6A, the edge portions 604 of the substrate 602 attach to the item 612 via adhesive, and the dielectric 608 can provide structural support. The adhesive can be selectively applied to only the substrate, but not the dielectric 608, allowing the resulting structure to remain flexible and easy to position without the risk of the dielectric 608 inadvertently sticking to itself during positioning onto the item 612. Additionally, if the item 612 is metal, the closer proximity of the substrate 602 to the item 612 can provide coupling that can create an improved loop effect. The improved loop effect can allow the edge-attachable RFID tag 600 to continue to operate even when against a metal surface which can substantially impact known RFID tags. In the embodiment presented in FIG. 6B, the edge portions 604 of the substrate 602 of the RFID tag 600 can be turned out and attached to the item 612 via adhesive on the substrate 602. In the embodiment presented in FIG. 6C, the edge-attachable RFID tag 600 is configured such that the edge portions 604 of the substrate 602 are pushed together to form a radio frequency (“RF”) path that closes the loop and allows the edge-attachable RFID tag 600 to continue to operate even with one side against a metal surface. Adhesive can be used to secure the edge-attachable RFID tag 600 to the metal surface.

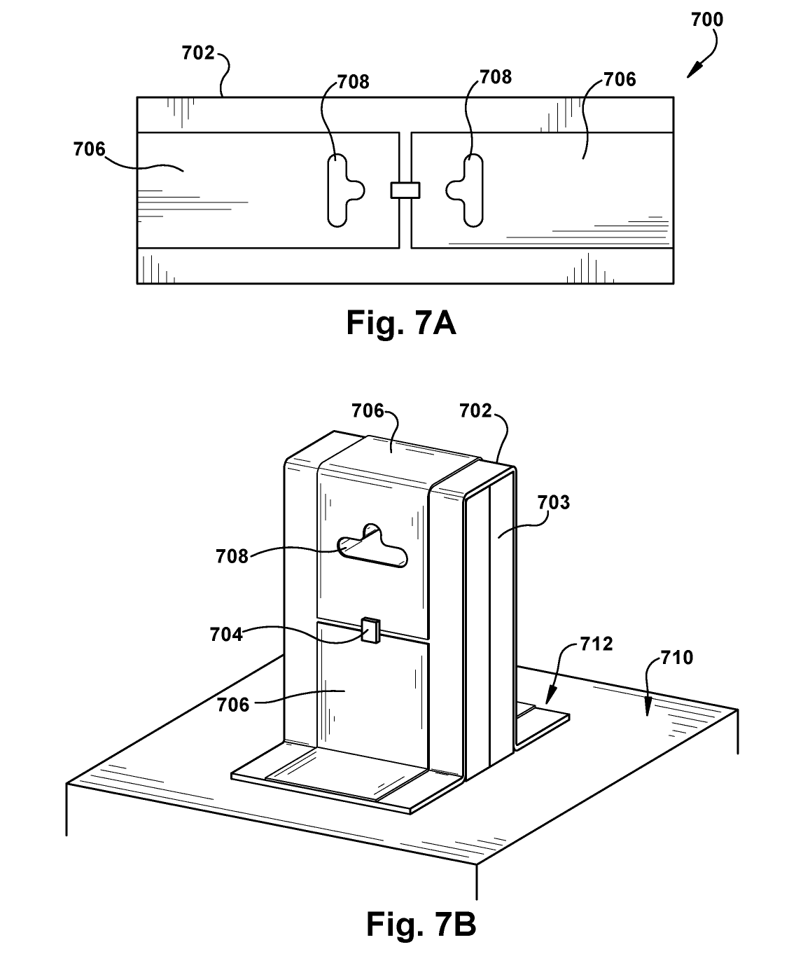

FIGS. 7A, and 7B illustrate an edge-attachable RFID tag 700 configured for use in retail establishments where items can be placed on display rails typical of retail environments. The edge-attachable RFID tag 700 includes a substrate 702, an RFID chip 704, antenna 706, a pair of opposing holes 708, and dielectric 703 such as foam or plastic. When the edge-attachable RFID tag 700 is folded, as illustrated in FIG. 7B, the opposing holes 708 can align and can allow the edge-attachable RFID tag 700 to slide onto a display rail. The folded substrate 702 and dielectric 703 can provide strength and durability for holding the item vertically on the display rail. The folded substrate 702 and dielectric 703 can also prevent the edge-attachable RFID tag 700 from tearing when the item 710 is pulled off of the display rail by customers. End portions 712 of the substrate 702 can be turned out and mounted to the item of commerce using an adhesive applied to the end portions 712 of the substrate 702.

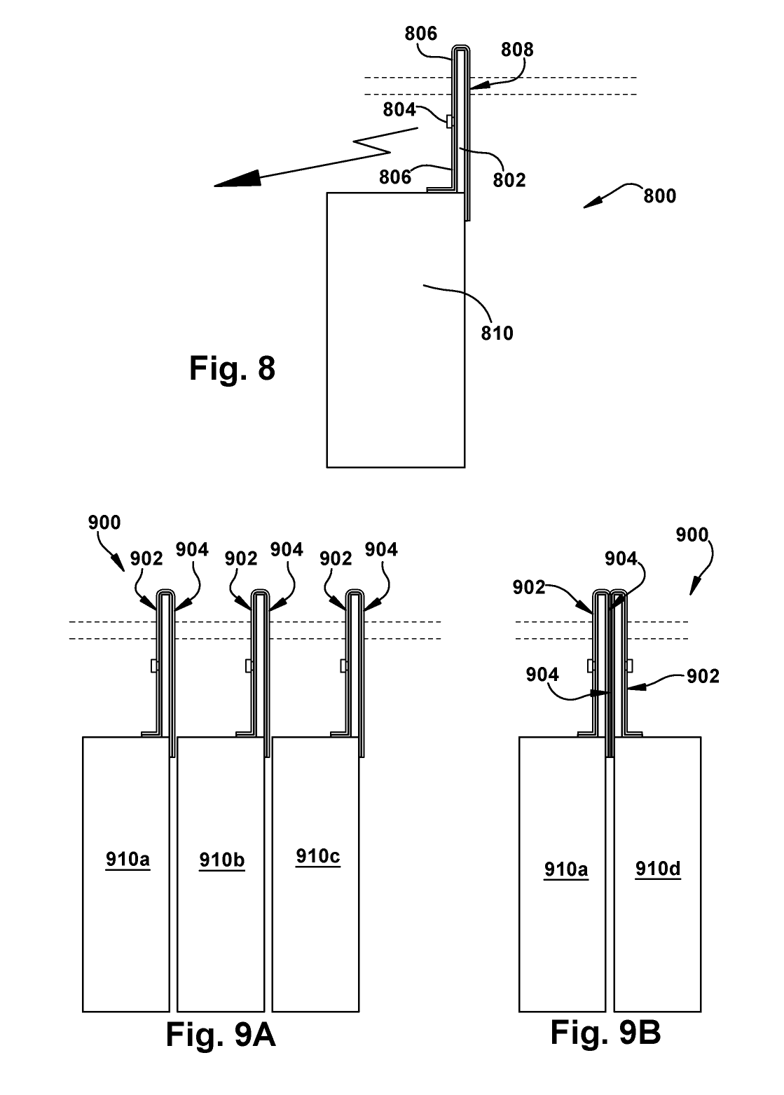

FIG. 8 illustrates an edge-attachable RFID tag 800 configured to be applied to a metal package 810 or a package associated with a metal item. Part of the front surface of substrate 802 is turned out and attached to the top metal package 810, while the back surface of the substrate 802 is attached to the back of the metal package 810. When joined, the edge-attachable RFID tag 800 and metal package 810 can form a loop antenna structure. The RFID chip 804 is positioned on the front surface and can radiate in a direction primarily forward from the front surface while the back surface is largely isolated. When the metal package 810 is correctly mounted on a display rail, the edge-attachable RFID tag 800 can easily be read by an overhead or handheld RFID reader system in the retail establishment. As the back surface is largely isolated, the performance of the edge-attachable RFID tag 800 is not affected if the metal package 810 is pushed to the back of the rail where a metal surface on an associated rack might otherwise impact performance.

FIGS. 9A and 9B illustrate packages 910A, 910B, and 910C (collectively packages 910) having edge-attachable RFID tags 900 that have been placed on a display rail. The packages 910 can be properly oriented on the display rails or arms, as illustrated in FIG. 9A such that all of the front surfaces 902 face one direction, and all of the back surfaces face the opposite direction. However, if a customer were to take one of the packages 910 off of the display rail and replace that package 910 in an inverted orientation, as illustrated in FIG. 9B, then conventional RFID tags could come into contact with one another which could reduce or inhibit proper performance of the conventional RFID tags. However, by advantageously using edge-attachable RFID tags and packaging disclosed in FIG. 8, such an inversion would result in isolated back surfaces 904 abutting one another which would result in a minimal reduction in the performance of either of active front surfaces 902 of the edge-attachable RFID tags 900.

The values disclosed herein are not to be understood as being strictly limited to the exact numerical values recited. Instead, unless otherwise specified, each such dimension is intended to mean both the recited value and a functionally equivalent range surrounding that value. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A radio frequency identification (“RFID”) transponder, comprising:
a foldable substrate configured to fold into a substantially U-shaped configuration, the foldable substrate having a first distal end portion and a second distal end portion each configured to attach to an item of commerce when in a folded configuration;
an antenna attached to the substrate; and
an RFID chip in electrical communication with the antenna.

2. The RFID transponder of claim 1, wherein each distal end portion includes a layer of adhesive configured to secure the RFID transponder to the item of commerce when the substrate is in the folded configuration.

3. The RFID transponder of claim 1, wherein the foldable substrate includes a pair of display rail holes, and wherein when the substrate is in the folded configuration, the display rail holes align to allow a display rail to be passed between the display rail holes.

4. The RFID transponder of claim 1, further comprising:
a dielectric attached to the substrate on a surface opposite from the antenna and RFID chip.

5. The RFID transponder of claim 4, wherein the dielectric is one or more of a foam or a plastic.

6. The RFID transponder of claim 4, wherein when the substrate is in the folded configuration the dielectric is folded between inner surfaces of the substrate and provides physically support for the RFID transponder.

7. The RFID transponder of claim 4, wherein when the dielectric covers only a portion of the substrate, and wherein each distal end portion of the substrate includes a layer of adhesive configured to secure the RFID transponder to the item of commerce when the substrate is in the folded configuration.

8. The RFID transponder of claim 7, wherein when each distal end portion of the substrate is secured to a metallic item of commerce, the metallic item functions as a part of a loop antenna for the RFID transponder.

9. The RFID transponder of claim 4, further comprising:
an adhesive layer on a surface of the dielectric opposite from the substrate.

10. The RFID transponder of claim 9, wherein when the substrate is in the folded configuration the adhesive layer on the dielectric attaches to one or more of the item of commerce or an adjacent surface of the dielectric.

11. The RFID transponder of claim 1, wherein the antenna and the RFID chip are positioned on the substrate such that when the substrate is in the folded configuration the RFID transponder transmits substantially from a side of the RFID transponder that includes the RFID chip.

12. The RFID transponder of claim 1, wherein a side of the RFID transponder opposite the RFID chip substantially insulates the RFID transponder such that positioning the RFID transponder adjacent to a metal surface or another RFID transponder does not substantially impact operation of the RFID transponder.

13. A radio frequency identification (“RFID”) tag, comprising:
a flexible substrate;
an antenna in communication with a first side of the substrate;
an RFID chip in communication with the antenna; and
one or more adhesive layers in communication with at least a portion of a second side of the substrate,
wherein the flexible substrate is configured to fold such that distal ends of the second side of the flexible substrate are in close proximity to, and opposing, one another.

14. The RFID tag of claim 13, wherein at least one of the distal ends includes an adhesive layer, and
wherein the distal ends are configured to be secured to:
an edge of an item;
a common surface of an item by turning each distal end outward; or
the other distal end by pressing the distal ends together.

15. The RFID tag of claim 13, wherein the antenna and the RFID chip are positioned on the first surface of the substrate such that when the substrate is folded, the RFID chip and antenna are positioned substantially on one side of the RFID tag and configured to transmit substantially in a direction approximately outward from the RFID chip.

16. The RFID tag of claim 13, further comprising:
a dielectric attached to at least a portion of the second surface of the substrate,
wherein the dielectric is one or more of a foam or a plastic, and
wherein when the substrate is folded, the dielectric is folded between opposing sides of the second surface of the substrate to provide physical support for the RFID tag.

17. A method, comprising:
attaching a distal portion of a substrate of a radio frequency identification (“RFID”) tag to an item of commerce;
folding the substrate approximately at the midpoint to substantially form a U-shape;
attaching an opposing distal portion of the substrate to the item of commerce,
wherein the RFID tag includes an antenna attached to an outer surface of the substrate, and a radio frequency identification (RFID) chip in electrical communication with the antenna, and
wherein the antenna and RFID chip are positioned on the substrate such that when the substrate is folded, the RFID chip and the antenna are substantially on one side of the RFID tag.

18. The method of claim 17, wherein the RFID tag includes a dielectric attached to the substrate, wherein the operation of folding the substrate folds the dielectric between opposing inner surfaces of the substrate, wherein the substrate and dielectric support the RFID tag when attached to the item of commerce.

19. The method of claim 17, further comprising:
transmitting, by the RFID tag, in a direction substantially outward from the side of the substrate that includes the antenna and RFID chip when the opposing side of the substrate is adjacent to a second item of commerce or a metallic surface.

20. The method of claim 17, wherein the RFID chip and further comprising:
turning out the distal ends of the substrate prior to attaching the distal ends of the substrate to a surface of the item of commerce.
